(19) United States
(12) Patent Application Publication
(10) Pub. No.: US 2024/0259628 A1
(43) Pub. Date: Aug. 1, 2024

(54) METHOD FOR DISPLAYING INFORMATION

(71) Applicant: BEIJING DAJIA INTERNET INFORMATION TECHNOLOGY CO., LTD., Beijing (CN)

(72) Inventors: Minjie XIE, Beijing (CN); Wei XU, Beijing (CN); Baoxuan WAN, Beijing (CN); Xin WU, Beijing (CN); Xiaoyu ZHANG, Beijing (CN); Jing LI, Beijing (CN)

(21) Appl. No.: 18/367,102

(22) Filed: Sep. 12, 2023

(30) Foreign Application Priority Data
Jan. 28, 2023 (CN) 202310084876.8

(51) Int. Cl. H04N 21/431; H04N 21/2187

(52) U.S. Cl. CPC H04N 21/4316; H04N 21/2187

(57) ABSTRACT

A method for displaying information include: in response to an operation of entering a virtual room, displaying a live interface of the virtual room, and displaying a visual element corresponding to the virtual room in the live interface, in which the visual element comprises a type of a resource provided by the virtual room, and current evaluation information of the virtual room with the type of the resource; and in response to a trigger operation on the visual element, displaying an information window corresponding to the virtual room on the live interface, and displaying the visual element and historical interaction object feature information corresponding to the virtual room in the information window.

### CROSS-REFERENCE TO RELATED APPLICATIONS

The present application claims the benefit of priority to Chinese Application No. 202310084876.8, filed on Jan. 28, 2023, the contents of which are incorporated herein by reference in their entireties for all purposes.

### FIELD

The present disclosure relates to the field of Internet technologies, and in particular to a method and an apparatus for displaying information, an electronic device, a storage medium and a computer program product.

### BACKGROUND

With the development of live broadcast technology, a live stream room may be used as a carrier to provide and transfer resources. At present, information presented or displayed in the live stream room is relatively fixed, and when a user enters one live stream room, the user usually takes a relatively long time to determine whether the live stream room meets the user's needs, which increases time cost in user operation and is less efficient for the user determination. Therefore, at present, there is a problem of restricted information displayed in the live stream room.

### SUMMARY

According to a first aspect of the present disclosure, a method for displaying information is provided, including: in response to an operation of entering a virtual room, displaying a live interface of the virtual room, and displaying a visual element corresponding to the virtual room in the live interface, in which the visual element includes a type of a resource provided by the virtual room, and current evaluation information of the virtual room with the type of the resource; and in response to a trigger operation on the visual element, displaying an information window corresponding to the virtual room on the live interface, and displaying the visual element and historical interaction object feature information corresponding to the virtual room in the information window.

According to a second aspect of the present disclosure, an electronic device is provided, including: a processor; and a memory for storing instructions executable by the processor: in which the processor is configured to execute the instructions to implement the method for information display according to the embodiments of the first aspect.

According to a third aspect of the present disclosure, a non-transitory computer-readable storage medium is provided. The non-transitory computer-readable storage medium has stored therein instructions that, in response to the instructions being executed by a processor of an electronic device, cause the electronic device to perform the method for information display according to the embodiments of the first aspect.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, but do not constitute an improper limitation on the present disclosure.

FIG. 1 is a flow chart of a method for displaying information according to an embodiment.

FIG. 2 is a schematic diagram illustrating a visual element according to an embodiment.

FIG. 3 is a schematic diagram illustrating an information window according to an embodiment.

FIG. 4 is a schematic diagram illustrating a visual element according to another embodiment.

FIG. 5 is a schematic diagram illustrating target tag information according to an embodiment.

FIG. 6 is a schematic diagram illustrating target tag information according to another embodiment.

FIG. 7 is a flow chart of a method for displaying information according to another embodiment.

FIG. 8 is a block diagram illustrating an apparatus for displaying information according to an embodiment.

FIG. 9 is a block diagram illustrating an electronic device according to an embodiment.

### DETAILED DESCRIPTION

In order to enable the skilled in the art better understand the technical solution of the present disclosure, description will be made clearly and completely below to the technical solution in embodiments of the present disclosure with reference to accompanying drawings in embodiments of the present disclosure.

It should be noted that terms “first”, “second”, and the like in the specification and the claims of the present disclosure, as well as in the above-described drawings, are used for distinguishing similar objects and not necessarily for describing a particular sequential or chronological order. It should be noted that data so used are interchangeable under appropriate circumstances such that embodiments of the present disclosure described herein may be implemented in sequences other than those illustrated or otherwise described herein. Embodiments described in the following illustrative examples do not represent all embodiments consistent with the present disclosure.

It should also be noted that user information (including, but not limited to, user equipment information, user personal information, etc.) and data (including, but not limited to, data for presentation, data for analysis, etc.) involved in the present disclosure are information and data authorized by the users or fully authorized by all parties.

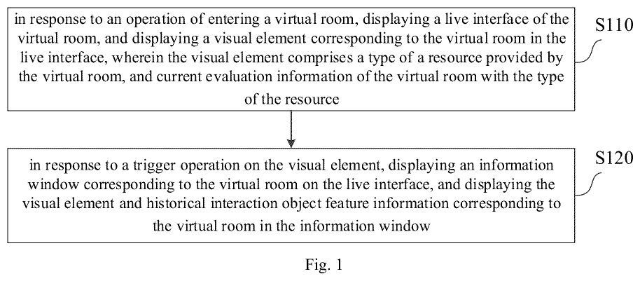

FIG. 1 is a flow chart of a method for displaying information according to an embodiment. As shown in FIG. 1, the method may be performed by a computer device such as a terminal, which may be, but is not limited to, various personal computers, notebook computers, smart phones, tablet computers, Internet of Things devices and portable wearable devices, and the method includes the following steps.

At block S110, in response to an operation of entering a virtual room, a live interface of the virtual room is displayed, and a visual element corresponding to the virtual room in the live interface is displayed.

The virtual room may be a live stream room (also called a live broadcast room), and audience users may enter the live stream room through a trigger operation on an entrance of the live stream room (for example, the entrance may be a small icon displayed on an interface of a live-broadcasting platform, the user clicks on the icon to enter the live stream room), and the live stream room may provide resources for live stream and interaction, for example, may perform live selling.

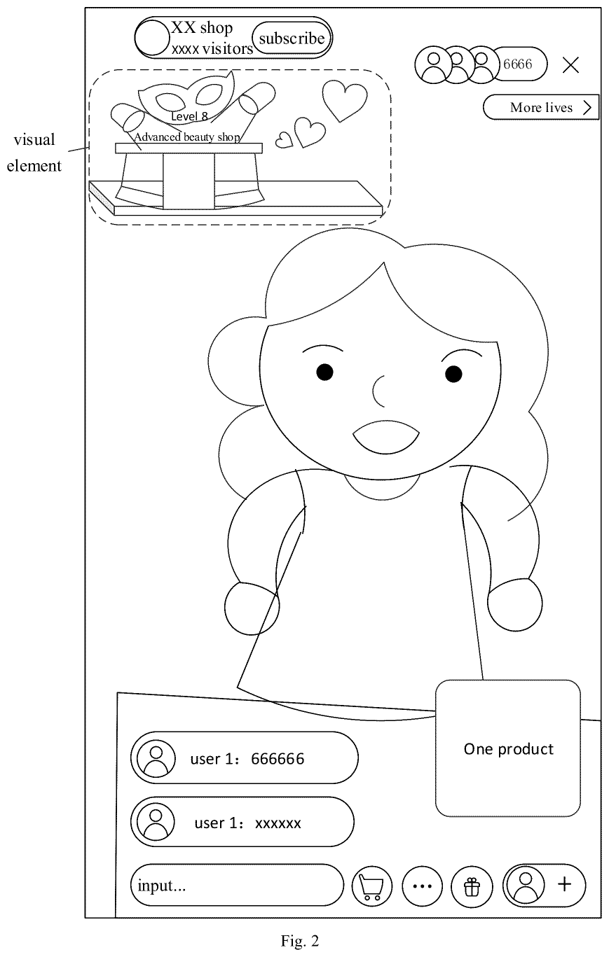

As an example, the visual element includes a type of a resource provided by the virtual room, and current evaluation information of the virtual room with the type of the resource. Taking the live stream room for selling as an example, the type of the resource may characterize a type of a product sold in the live stream room, and the current evaluation information may characterize a current evaluation condition of the live stream room with the type of the product. For example, for the live stream room with a type of beauty makeup, the current evaluation may be primary or advanced. As shown in FIG. 2, the visual element may be a virtual widget having a visual element style corresponding to the current evaluation information.

In practical applications, a user equipment corresponding to the audience user may respond to the operation of entering the virtual room, such as a trigger operation of the audience user on the entrance of the live stream room, the user equipment may display the live interface of the virtual room, and may display the visual element corresponding to the virtual room in the live interface, so that the audience user may acquire, according to the displayed visual element, the type of the resource provided by the virtual room, and current evaluation information of the virtual room with the type of the resource.

Specifically, as shown in FIG. 2, after the audience user enter a live stream room for selling a certain kind of items, a displayed virtual widget (namely, the visual element) having a corresponding visual element style may be seen in a left upper corner area of the live interface of the live stream room, and the type of the resource provided by the live stream room may be displayed on the virtual widget, as shown in FIG. 2, “beauty shop”, so that the audience users may quickly learn that the items sold in the live stream room are mainly in the beauty type, which helps the user to efficiently determine whether the user has interest in the live stream room. The virtual widget may further present the current rating information of the live stream room with the type of the resource, such as “advanced beauty shop” and “level 8” in FIG. 2.

In an example, the type of the product sold in the live stream room is shown to the user entered the live stream room in a visual expression manner by displaying the visual element corresponding to the virtual room in the upper left corner area of the live interface. In this way, the user entered the live stream room may quickly know whether the live stream room is suitable for oneself. For example, for users who do not need to purchase beauty products, after entering the live stream room as shown in FIG. 2, the users may efficiently determine that the live stream room is not be suitable for themselves according to the displayed visual element, and the users do not need to spend a lot of time to acquire information about the live stream room for the determination, which reduces time that the users operations spends.

In an alternative embodiment, the live stream rooms of other types, such as a music live stream room, and a game live stream room, may have the visual element corresponding to the live stream room displayed in the live interface, which is not specifically limited in the present embodiments. The audience users who enter the live stream room may acquire live content-related information of the live stream room, such as a type of music in the music live stream room or a type of games in the game live stream room, via the displayed visual element, thereby enabling the users who enter the live stream room to quickly determined whether the live stream room is suitable for themselves.

At block S120, in response to a trigger operation on the visual element, an information window corresponding to the virtual room is displayed on the live interface, and the visual element and historical interaction object feature information corresponding to the virtual room are displayed in the information window:

In an embodiment, in response to the trigger operation on the visual element, for example, the audience user may click on the displayed visual element, the information window corresponding to the virtual room is displayed on the live interface, and more information about the live stream room may be displayed in the information window; for example, the visual element and the historical interaction object feature information corresponding to the virtual room are displayed. In this way, the audience user may further learn relevant information about the live stream room in detail according to evaluation information, vertical class information, historical interaction object feature information of the live stream room displayed in the information window; which is helpful for the users to effectively determine a degree of adaptation of the live stream room to their own needs.

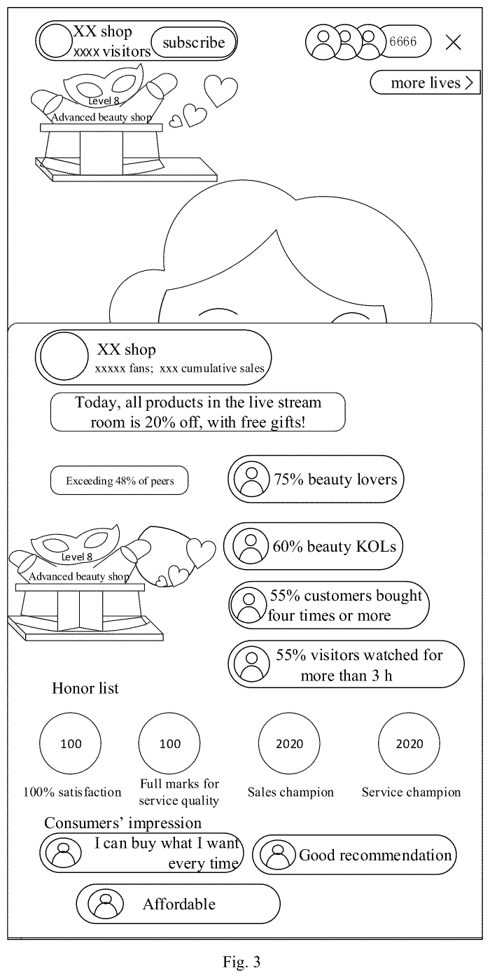

In an example, the information window corresponding to the virtual room may be displayed on the live interface in a half-screen display manner. Taking the live stream room for selling goods as an example, as shown in FIG. 3, the visual element (such as the virtual widget corresponding to the “advanced beauty shop” in FIG. 3) and the historical interaction object feature information (such as “75% beauty lovers” and “55% customers who have bought 4 times or more” in FIG. 3) corresponding to the virtual room may be displayed in the information window, and the historical interaction object feature information may be analyzed and calculated according to historical item sale information and historical live record information corresponding to the virtual room to provide data for the users to learn more about the purchasers in the live stream room.

In another example, the information window displayed in the half-screen display manner may further include user evaluation information, such as a comment presentation of a consumer impression in FIG. 3. In a case that the trigger operation on the visual element is detected, the information window is displayed on the live interface according to a preset half-screen display rule (such as a half-screen display size, a half-screen display position, etc.).

In the method for displaying information, in response to the operation of entering the virtual room, the live interface of the virtual room is displayed and the visual element corresponding to the virtual room in the live interface is displayed, and in response to the trigger operation on the visual element, the information window corresponding to the virtual room is displayed on the live interface and the visual element and historical interaction object feature information corresponding to the virtual room are displayed in the information window. In this way, on the basis of displaying the visual element including the type of the resource provided by the virtual room in the live interface, the information of the live stream room can be provided and displayed in the multiple states that can be switched, which enriches the information displayed in the live stream room, so that the users entered the live stream room may quickly learn whether the live stream room is suitable for themselves. Further, the historical interaction object feature information displayed in the information window may help the users to acquire relevant information about the live stream room to make the decision effectively, thereby reducing operating time for the users and improving the interaction efficiency of the live stream.

In an embodiment, the current evaluation information includes first evaluation information, and the virtual room has different visual element styles corresponding to different first evaluation information, and displaying the visual element corresponding to the virtual room in the live interface includes: displaying a virtual widget including the first evaluation information and type information of the resource provided by the virtual room, in the visual element style corresponding to the first evaluation information, in the live interface as the visual element corresponding to the virtual room.

For example, the first evaluation information may be acquired according to primary, intermediate and advanced evaluation settings, or other evaluation settings, which are not particularly limited in the embodiments. In a case that the virtual room has different evaluations, the visual element corresponding to the virtual room is presented in different visual element styles, for example, evaluation of primary, intermediate or advanced level may correspond to a different visual element style.

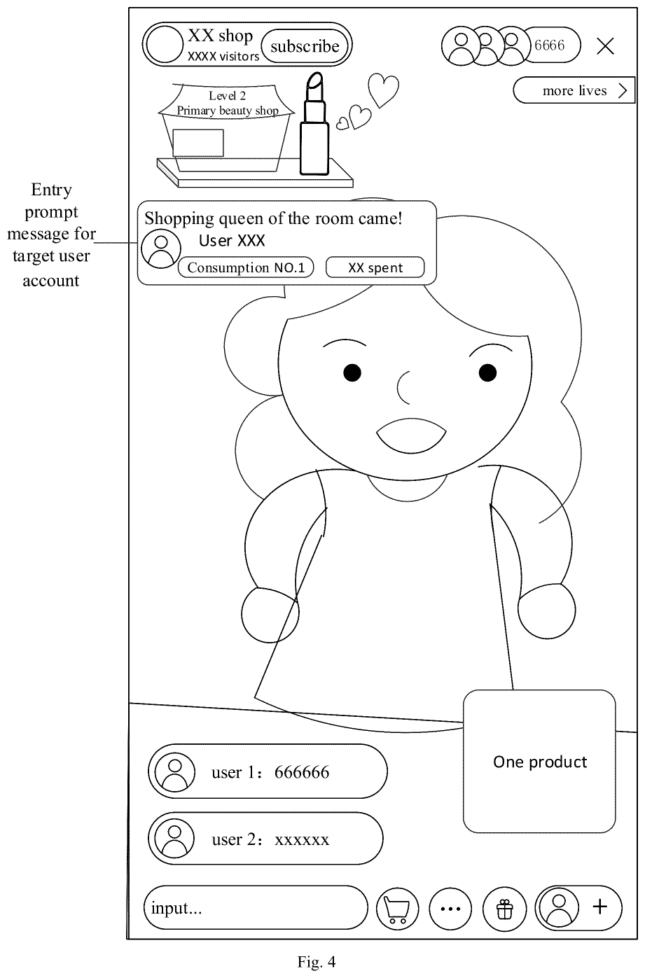

In an example, the live stream room is for selling goods, as shown in FIG. 4, the virtual room is at the primary level of the beauty type, the virtual widget is displayed in the live interface in the visual element style corresponding to the primary level, and “primary beauty shop”, showing the first evaluation information and the type information of the resource provided by the virtual room, is displayed on the virtual widget.

In another example, the live stream room is for selling goods, as shown in FIG. 2, the virtual room is at the advanced level of the beauty type, the virtual widget is displayed in the live interface in the visual element style corresponding to the advanced level, and “advanced beauty shop”, showing the first evaluation information and the type information of the resource provided by the virtual room, is displayed on the virtual widget. Therefore, based on the switch of the multiple states of the visual element displayed in the live stream room, the users entered the live stream room may quickly acquire the type of the resource provided by the virtual room and distinguish the current evaluation information of the virtual room with the type of the resource from others.

In an optional embodiment, in a case that a change in the evaluation information of the virtual room is detected, for example, the virtual room is upgraded from the primary level to the intermediate level, the displayed visual element may be updated and displayed in the live interface, and the latest first evaluation information and the type information of the resource provided by the virtual room are displayed on the updated visual element. That is, the virtual widget displayed in the visual element style corresponding to, for example, the primary level is replaced with the virtual widget displayed in the visual element style corresponding to the intermediate level.

In an embodiment, regarding different resource types, visual element styles set corresponding to different first evaluation information for each resource type are different. In a case that a change of the type information of the resource of the virtual room is detected, for example, the type of the resource corresponding to the virtual room is changed, the visual element displayed in the live interface may be updated in combination with the resource type and the first evaluation information corresponding to the virtual room, and the updated visual element can present updated first evaluation information and updated type information of the resource provided by the virtual room.

According to the technical solution of the embodiments, the virtual widget including the first evaluation information and type information of the resource provided by the virtual room is displayed, in the visual element style corresponding to the first evaluation information, in the live interface as the visual element corresponding to the virtual room, which may provide the information of the live stream room in multiple states that can be switched, and thus the users entered the live stream room may quickly acquire the type of the resource provided by the virtual room, and distinguish the first evaluation of the virtual room with the type of the resource from others.

In an embodiment, the current evaluation information further includes second evaluation information, the first evaluation information has a hierarchical relationship with the second evaluation information, a level to which the first evaluation information belongs is higher than a level to which the second evaluation information belongs, a plurality of pieces of second evaluation information corresponds to the same first evaluation information, and displaying the virtual widget including the first evaluation information and the type information of the resource provided by the virtual room includes: displaying a virtual widget including the first evaluation information, the second evaluation information and the type information of the resource provided by the virtual room in the live interface.

For example, the second evaluation information may be acquired according to a numerical ascending order setting, or other evaluation settings, which is not particularly limited in the embodiments. In a case that the virtual rooms are at the same level to which the first evaluation information belongs, they can be distinguished from each other by a plurality of second evaluation information corresponding to the first evaluation information, such as levels 1-5 at the primary level, levels 1-5 at the intermediate level, and levels 1-5 at the advanced level.

For example, the live stream room is for selling goods, as shown in FIG. 4, the virtual room is currently at the primary level of the beauty type, the virtual widget may be displayed in the live interface in the visual element style corresponding to the primary level, and the first evaluation information (i.e., “primary”), the second evaluation information (i.e., “level 2”) and the type information (i.e., “beauty shop”) of the resource provided by the virtual room are displayed on the virtual widget.

For another example, the live stream room is for selling goods, as shown in FIG. 2, the virtual room is currently at the advanced level of the beauty type, the virtual widget may be displayed in the live interface in the visual element style corresponding to the advanced level, and the first evaluation information (i.e., “advanced”), the second evaluation information (i.e., “level 8”) and the type information (i.e., “beauty shop”) of the resource provided by the virtual room are displayed on the virtual widget.

In an optional embodiment, in a case that a change in the evaluation information of the virtual room is detected, for example, the virtual room is upgraded from level 2 to level 3 at the primary level, the displayed second evaluation information may be updated in the live interface, for example, “level 2 primary beauty shop” is replaced with “level 3 primary beauty shop”.

According to the technical solution of the embodiment, the information displayed in the live stream room is enriched by displaying the virtual widget including the first evaluation information, the second evaluation information and the type information of the resource provided by the virtual room in the live interface.

In an embodiment, before displaying the visual element corresponding to the virtual room in the live interface, the present method further includes: acquiring a preset resource type configured for the virtual room; and determining the type of the resource provided by the virtual room according to the preset resource type.

The preset resource type may be configured by an anchor user account corresponding to the virtual room, for example, the type of the product sold in the live stream room may be preset by the anchor user account.

In an embodiment, the preset resource type configured for the virtual room may be acquired, the type of the resource provided by the virtual room is determined according to the preset resource type, and the type information of the resource provided by the virtual room may be acquired and displayed on the visual element in the live interface.

According to the technical solution of the embodiment, the type information of the resource provided by the virtual room may be acquired according to the preset resource type by acquiring the preset resource type configured for the virtual room, and determining the type of the resource provided by the virtual room according to the preset resource type, thus providing data support for displaying the visual element.

In an embodiment, determining the type of the resource provided by the virtual room according to the preset resource type includes: in a case that one preset resource type exists, determining the type of the resource provided by the virtual room according to the one preset resource type; and in a case that at least two preset resource types exist, determining a target resource type from the at least two preset resource types according to historical resource supply quantity information for each of the at least two preset resource types for the virtual room, and determining the type of the resource provided by the virtual room according to the target resource type. A historical resource supply quantity corresponding to the target resource type is greater than a historical resource supply quantity corresponding to any other preset resource type in the virtual room.

In an example, the one preset resource type configured for the virtual room is acquired, the one preset resource type is determined as the type of the resource provided by the virtual room to acquire the type information of the resource provided by the virtual room.

In another example, at least two preset resource types configured for the virtual room are acquired, for the virtual room, the historical resource supply quantity information corresponding to each of the preset resource types is compared with each other. For example, in a case that multiple types of the products/goods for sale in the live stream room for selling goods are preset by the anchor user account, historical sale information corresponding to each of the types of the products may be acquired, and the preset resource type corresponding to the maximum historical resource supply quantity may be taken as the target resource type, and the target resource type is determined as the type of the resource provided by the virtual room, to acquire the type information of the resource provided by the virtual room, thus presenting the type of the resource provided by the virtual room.

According to the technical solution of the embodiment, in the case that one preset resource type exists, the type of the resource provided by the virtual room is determined according to the one preset resource type, and in the case that at least two preset resource types exist, the target resource type is determined from the at least two preset resource types according to the historical resource supply quantity information for each of the at least two preset resource types in the virtual room, and the type of the resource provided by the virtual room is determined according to the target resource type. In this way; the type of the resource provided by the virtual room may be presented for the users to make the effective determination.

In an embodiment, after displaying the visual element corresponding to the virtual room in the live interface, the present method further includes: in a case that it is detected that a target user account enters the virtual room, displaying an entry prompt message for the target user account in the live interface. The target user account has a target user identifier, the target user identifier indicates that an interaction degree of the target user account in a target domain is higher than a set threshold, and the target domain is a domain corresponding to the type of the resource provided by the virtual room.

For example, the target user account may be a user account of a Key Opinion Leader (KOL) type, which may access more and accurate resource information. Moreover, the user having the KOL account is popular in or trusted by a relevant group in a domain of a certain resource type, and has a greater influence on the resource interaction behavior of the relevant group.

In an embodiment, as shown in FIG. 4, in a case that it is detected that the target user account enters the virtual room, the entry prompt message for the target user account is displayed in the live interface. For example, a prompt information card may be displayed at a position below the visual element, and an account identification of the target user account and other identification information corresponding to the target user account may be displayed in the prompt information card.

According to the technical solution of the embodiment, in the case that it is detected that the target user account enters the virtual room, the entry prompt message for the target user account is displayed in the live interface, which provides more resource interaction reference information for the audience users in the virtual room.

In an embodiment, after displaying the visual element corresponding to the virtual room in the live interface, the present method further includes: in a case that target tag information corresponding to the virtual room is acquired, displaying the target tag information at a peripheral position of the visual element. The target tag information includes at least one of the historical interaction object feature information, resource interaction activity information, and user evaluation information corresponding to the virtual room.

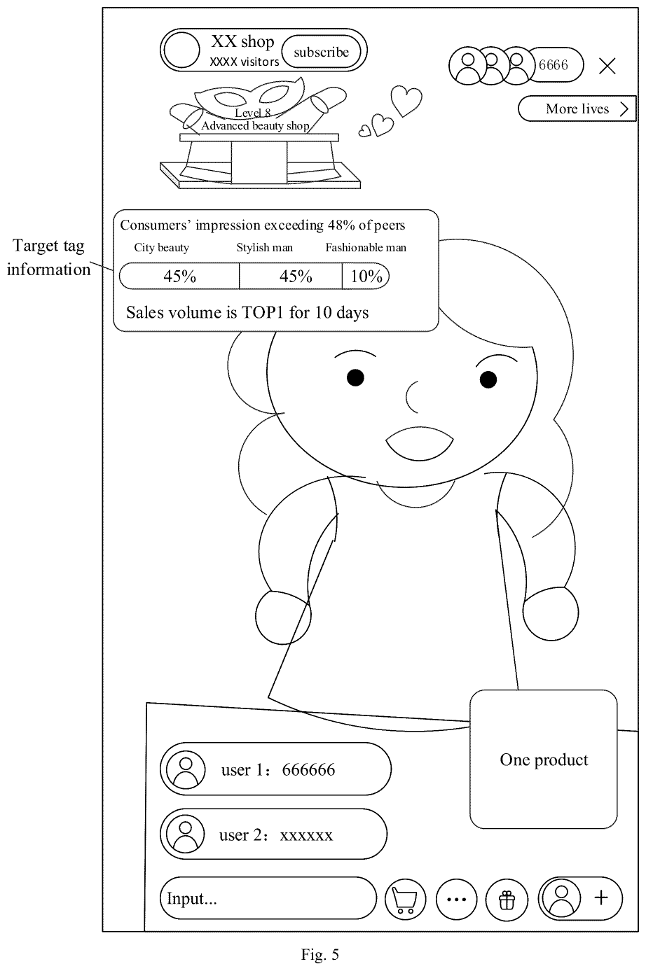

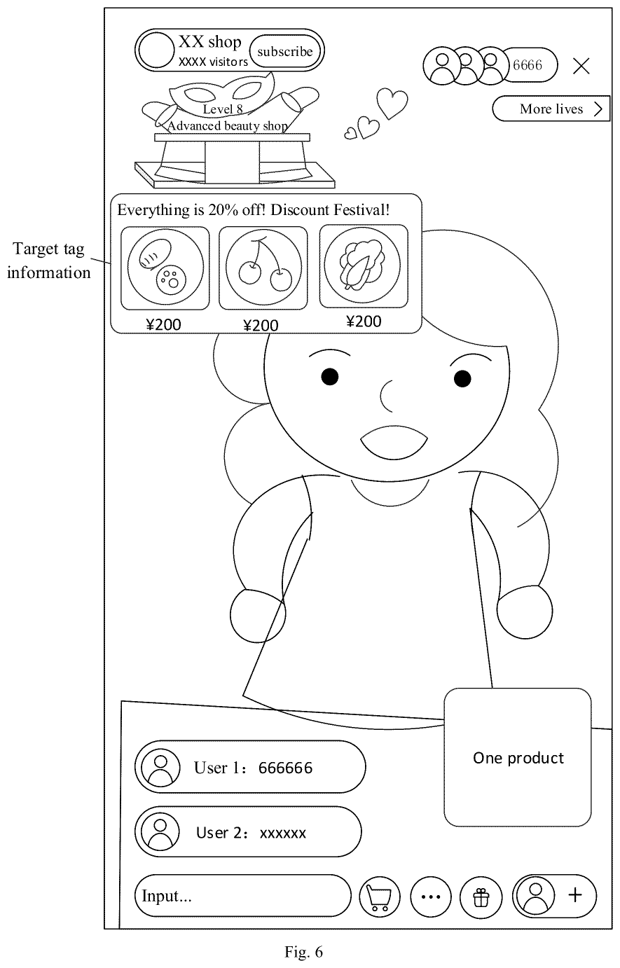

In practical applications, in a case that it is detected that the target tag information exists in the virtual room, for example, the target tag information regarding the virtual room sent by a server is received, the target tag information corresponding to the virtual room can be acquired, and the target tag information can be displayed at the peripheral position of the visual element. As shown in FIGS. 5 and 6, the target tag information such as the historical interaction object feature information, the resource interaction activity information, and the user evaluation information are displayed at the position below the visual element.

For example, as shown in FIG. 5, the historical interaction object feature information corresponding to the virtual room is displayed at the position below the visual element. Taking the live stream room for selling goods as an example, the historical interaction object feature information may represent a condition of purchasers corresponding to the live stream room for selling goods, and the feature information of the purchasers is presented. Purchaser property, purchase behavior and purchase data may be interconnected, to make the historical interaction object feature representative, and thus to indicate the historical interaction object feature of the type of the resource provided by the virtual room.

According to the technical solution of the embodiment, in the case that target tag information corresponding to the virtual room is acquired, the target tag information at the peripheral position of the visual element is displayed, which enriches the information displayed in the live stream room, helps the users quickly understand the live stream room, and improves the efficiency of the live interaction.

In an embodiment, displaying the target tag information at the peripheral position of the visual element in the case that the target tag information corresponding to the virtual room is acquired includes: in a case that the target tag information acquired is one type of tag information, periodically displaying the target tag information according to a set time interval; and in a case that the target tag information acquired is at least two types of tag information, alternately displaying the at least two types of tag information in a set order.

In an example, in the case that the target tag information acquired is one type of tag information, the received target tag information sent by the server may be periodically displayed according to the set time interval: in the case that the target tag information acquired is at least two types of tag information, different types of the target tag information sent by the server may be alternately displayed in the set order. As shown in FIGS. 5 and 6, the historical interaction object feature information and the resource interaction activity information may be alternately displayed in a display area of the target tag information.

According to the technical solution of the embodiment, in the case that the target tag information acquired is one type of tag information, the target tag information is displayed periodically according to the set time interval; and in the case that the target tag information acquired is at least two types of tag information, the at least two types of target tag information is displayed alternately in the set order, which may provide the audience users with more relevant information about the live stream room, help the users quickly understand the live stream room and improve the efficiency of the live interaction.

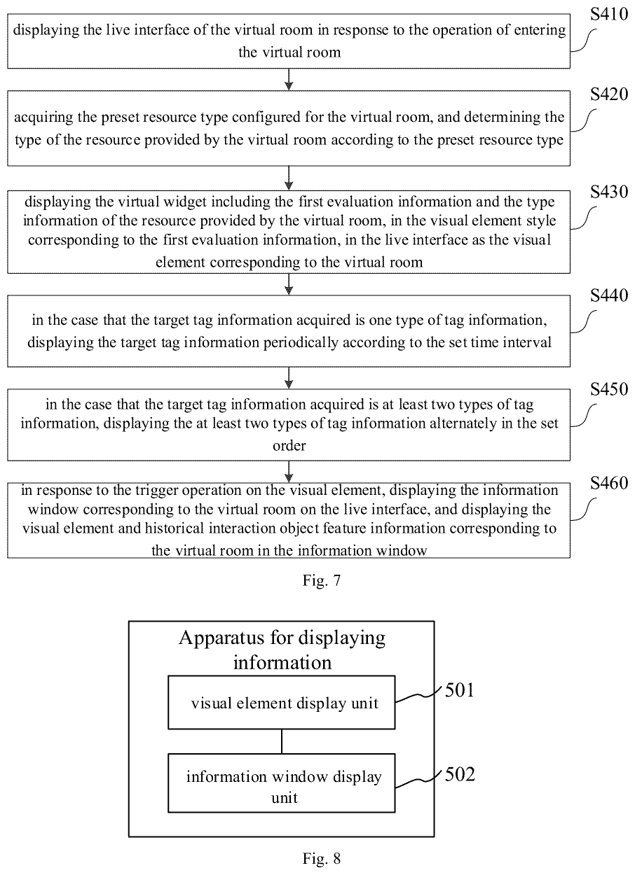

FIG. 7 is a flow chart of a method for displaying information according to some embodiments. As shown in FIG. 7, the method is performed by a computer device such as a terminal, and includes the following steps.

At block S410, the live interface of the virtual room is displayed in response to the operation of entering the virtual room. At block S420, the preset resource type configured for the virtual room is acquired, and the type of the resource provided by the virtual room is determined according to the preset resource type. At block S430, the virtual widget including the first evaluation information and the type information of the resource provided by the virtual room is displayed, in the visual element style corresponding to the first evaluation information, in the live interface as the visual element corresponding to the virtual room. At block S440, in the case that the target tag information acquired is one type of tag information, the target tag information is displayed periodically according to the set time interval. At block S450, in the case that the target tag information acquired is at least two types of tag information, the at least two types of tag information are displayed alternately in the set order. At block S460, in response to the trigger operation on the visual element, the information window corresponding to the virtual room is displayed on the live interface, and the visual element and the historical interaction object feature information corresponding to the virtual room are displayed in the information window: It should be noted that the specific limitations of the above operations may be referred to the specific limitations of the method for displaying information described in the above embodiments, and will not be repeated here.

It should be understood that, although the various embodiments described above relate to flow charts in which the various operations/steps are shown sequentially as indicated by arrows, the operations/steps do not need to be performed sequentially in the order indicated by the arrows. The operations/steps are performed in any appropriate order unless explicitly stated herein. Moreover, at least some of the operations/steps in the flow charts related to the embodiments described above may further include multiple steps or stages that are not necessarily performed at the same time, but may be performed at different times. The steps or stages may not happen in sequence, but in turn or in alternation with other steps or stages.

It may be understood that the same/similar parts of the above-described method in the various embodiments of the specification may be referred to each other. For one embodiment it usually focuses on describing the difference from the other embodiments, and the other relevant parts may refer to the description of the other method embodiments.

According to the same inventive concept, embodiments of the present disclosure further provides an apparatus for displaying information which may be configured to implement the method for displaying information.

FIG. 8 is a block diagram illustrating an apparatus for displaying information according to an embodiment. As shown in FIG. 8, the apparatus includes a visual element display unit 501 and an information window display unit 502.

The visual element display unit 501 is configured to, in response to an operation of entering a virtual room, display a live interface of the virtual room, and display a visual element corresponding to the virtual room in the live interface, where the visual element includes a type of a resource provided by the virtual room, and current evaluation information of the virtual room with the type of the resource.

The information window display unit 502 is configured to, in response to a trigger operation on the visual element display, an information window corresponding to the virtual room on the live interface, and display the visual element and historical interaction object feature information corresponding to the virtual room in the information window.

In an embodiment, the current evaluation information includes the first evaluation information, and the virtual room has different visual element styles corresponding to different first evaluation information. The visual element display unit 501 is specifically configured to display the virtual widget including the first evaluation information and the type information of the resource provided by the virtual room, in the visual element style corresponding to the first evaluation information, in the live interface as the visual element corresponding to the virtual room.

In an embodiment, the current evaluation information further includes second evaluation information, the first evaluation information has a hierarchical relationship with the second evaluation information, a level to which the first evaluation information belongs is higher than a level to which the second evaluation information belongs, and a plurality of pieces of second evaluation information corresponds to the same first evaluation information. The visual element display unit 501 is specifically configured to display the virtual widget including the first evaluation information, the second evaluation information and the type information of the resource provided by the virtual room in the live interface.

In an embodiment, the apparatus for displaying information further includes a preset resource type acquiring unit specifically configured to acquire a preset resource type configured for the virtual room, and a resource type determining unit specifically configured to determine the type of the resource provided by the virtual room according to the preset resource type.

In an embodiment, the resource type determining unit is specifically configured to, in a case that one preset resource type exists, determine the type of the resource provided by the virtual room according to the one preset resource type, and to, in a case that at least two preset resource types exist, determine a target resource type from the at least two preset resource types according to historical resource supply quantity information for each of the at least two preset resource types for the virtual room, and determine the type of the resource provided by the virtual room according to the target resource type. A historical resource supply quantity corresponding to the target resource type is greater than a historical resource supply quantity corresponding to any other preset resource type in the virtual room.

In an embodiment, the apparatus for displaying information further includes an entry prompt message displaying unit specifically configured to, in a case that it is detected that the target user account enters the virtual room, display the entry prompt message for the target user account in the live interface. The target user account has a target user identifier, the target user identifier indicates that an interaction degree of the target user account in a target domain is higher than a set threshold, and the target domain is a domain corresponding to the type of the resource provided by the virtual room.

In an embodiment, the apparatus for displaying information further includes a target tag information displaying unit specifically configured to, in a case that target tag information corresponding to the virtual room is acquired, display the target tag information at the peripheral position of the visual element. The target tag information includes at least one of the historical interaction object feature information, resource interaction activity information, and user evaluation information corresponding to the virtual room.

In an embodiment, the target tag information displaying unit is specifically configured to, in a case that the target tag information acquired is one type of tag information, periodically display the target tag information according to a set time interval, and in case that the target tag information acquired is at least two types of tag information, alternately display the at least two types of tag information in a set order.

Regarding the apparatus in the foregoing embodiments, the specific manner in which the various units/modules perform operations may refer to the details described in the embodiments related to the present method, and will not be described in detail again here.

The various units/modules in the apparatus for displaying information may be implemented in whole or in part by software, hardware, and combinations thereof. The above-mentioned units/modules may be in a form of hardware and are embedded in or independent of a processor in the computer device, or may be in a form of software and stored in a memory in the computer device, to be executed by a processor to perform the operations corresponding to the above-mentioned units.

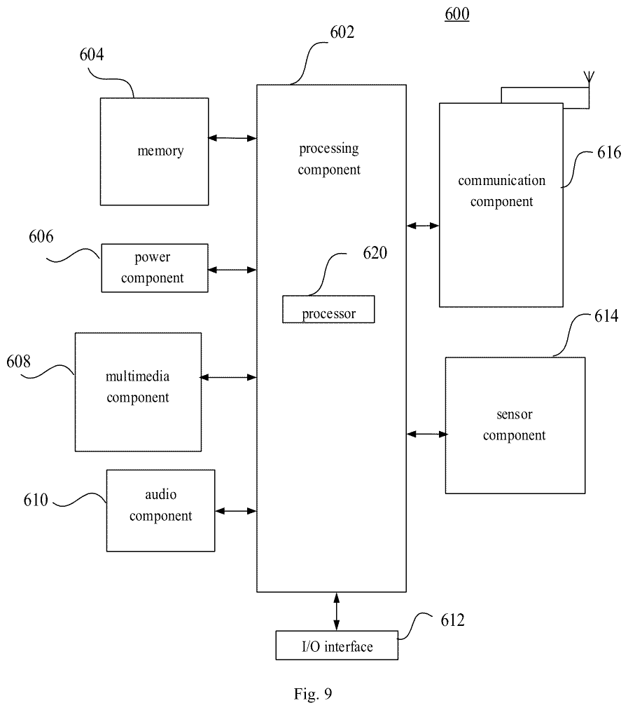

FIG. 9 is a block diagram illustrating an electronic device 600 capable of executing a method for displaying information according to an embodiment. For example, the electronic device 600 may be a mobile phone, a computer, a digital broadcast terminal, a messaging device, a game console, a tablet device, a medical device, an exercise device, or a personal digital assistant.

Referring to FIG. 9, the electronic device 600 may include one or more of: a processing component 602, a memory 604, a power component 606, a multimedia component 608, an audio component 610, an input/output (I/O) interface 612, a sensor component 614, and a communication component 616.

The processing component 602 normally controls the overall operation (such as operations associated with displaying, telephone calls, data communications, camera operations and recording operations) of the electronic device 600. The processing component 602 may include one or a plurality of processors 620 to execute instructions so as to perform all or part of the steps of the above method for displaying information according to embodiments of the present disclosure. In addition, the processing component 602 may include one or a plurality of units to facilitate interactions between the processing component 602 and other components. For example, the processing component 602 may include a multimedia unit to facilitate interactions between the multimedia component 608 and the processing component 602.

The memory 604 is configured to store various types of data to support operations at the electronic device 600. Examples of such data include instructions for any application or method operated on the electronic device 600, contact data, phone book data, messages, images, videos and the like. The memory 604 may be realized by any type of volatile or non-volatile storage devices, or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk, an optical disk or a graphene memory.

The power component 606 provides power to various components of the electronic device 600. The power component 606 may include a power management system, one or more power sources and other components associated with power generation, management, and distribution of the electronic device 600.

The multimedia component 608 includes a screen that provides an output interface between the electronic device 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may sense not only the boundary of the touches or sliding actions, but also the duration and pressure related to the touches or sliding operations. In some embodiments, the multimedia component 608 includes a front camera and/or a rear camera. When the electronic device 600 is in an operation mode such as a shooting mode or a video mode, the front camera and/or the rear camera may receive external multimedia data. Each front camera and rear camera may be a fixed optical lens system or have a focal length and an optical zoom capability:

The audio component 610 is configured to output and/or input an audio signal. For example, the audio component 610 includes a microphone (MIC) that is configured to receive an external audio signal when the electronic device 600 is in an operation mode such as a call mode, a recording mode, and a voice recognition mode. The received audio signal may be further stored in the memory 604 or transmitted via the communication component 616. In some embodiments, the audio component 610 also includes a speaker for outputting audio signals.

The I/O interface 612 provides an interface between the processing component 602 and a peripheral interface unit. The peripheral interface unit may be a keyboard, a click wheel, a button and so on. These buttons may include, but are not limited to, a home button, a volume button, a start button, and a locking button.

The sensor assembly 614 includes one or more sensors for providing the electronic device 600 with various aspects of status assessments. For example, the sensor component 614 may detect an ON/OFF state of the electronic device 600 and a relative positioning of the components. For example, the components may be a display and a keypad of the electronic device 600. The sensor component 614 may also detect a change in position of the electronic device 600 or a component of the electronic device 600, the presence or absence of contact of the user with the electronic device 600, the orientation or acceleration/deceleration of the electronic device 600 and a temperature change of the electronic device 600. The sensor component 614 may include a proximity sensor configured to detect the presence of nearby objects without any physical contact. The sensor component 614 may also include a light sensor (such as a CMOS or a CCD image sensor) for use in imaging applications. In some embodiments, the sensor component 614 may also include an acceleration sensor, a gyro sensor, a magnetic sensor, a pressure sensor, or a temperature sensor.

The communication component 616 is configured to facilitate wired or wireless communication between the electronic device 600 and other devices. The electronic device 600 may access a wireless network according to a communication standard such as 2G, 3G, 4G, 5G or a combination thereof. In an embodiment, the communication component 616 receives broadcast signals or broadcast-associated information from an external broadcast management system via a broadcast channel. In an embodiment, the communication component 616 also includes a near field communication (NFC) module to facilitate short range communication. For example, the NFC module may be implemented according to radio frequency identification (RFID) technology, infrared data association (IrDA) technology, ultra-wide band (UWB) technology, Bluetooth (BT) technology and other technologies.

In an embodiment, the electronic device 600 may be implemented by one or more application specific integrated circuits (ASICs), digital signal processors (DSPs), digital signal processing devices (DSPDs), programmable logic devices (PLDs), field programmable gate arrays (FPGA), controllers, microcontrollers, microprocessors, or other electronic components, so as to perform the above method.

In an embodiment, there is also provided a non-transitory computer-readable storage medium including instructions, such as included in the memory 604, executable by the processor 620 in the device 600, for performing the above-described method. For example, the non-transitory computer-readable storage medium may be a ROM, a RAM, a CD-ROM, a magnetic tape, a floppy disc, an optical data storage device, and the like.

In an embodiment, there is also provided a computer program product including instructions executable by the processor 620 of the electronic device 600 to perform the above-described method.

It should be noted that the above-described apparatus, electronic device, computer-readable storage medium, and computer program product may further include other embodiments according to the description of the embodiments of the present method, and the specific implementation may refer to the description of the embodiments of the relevant method, which will not be described in detail herein again.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as illustrated only, with a true scope and spirit of the present disclosure being indicated by the following claims.

It will be appreciated that the present disclosure is not limited to the exaction construction that has been described above and illustrated in the accompanying drawings, and that various modifications and changes can be made without departing from the scope thereof. It is intended that the scope of the present disclosure only be limited by the appended claims.

What is claimed is:

1. A method for displaying information, comprising:
in response to an operation of entering a virtual room, displaying a live interface of the virtual room, and displaying a visual element corresponding to the virtual room in the live interface, wherein the visual element comprises a type of a resource provided by the virtual room, and current evaluation information of the virtual room with the type of the resource; and
in response to a trigger operation on the visual element, displaying an information window corresponding to the virtual room on the live interface, and displaying the visual element and historical interaction object feature information corresponding to the virtual room in the information window.

2. The method of claim 1, wherein the current evaluation information comprises first evaluation information, and the virtual room has different visual element styles corresponding to different first evaluation information, and wherein displaying the visual element corresponding to the virtual room in the live interface comprises:
displaying a virtual widget comprising the first evaluation information and type information of the resource provided by the virtual room, in the visual element style corresponding to the first evaluation information, in the live interface as the visual element corresponding to the virtual room.

3. The method of claim 2, wherein the current evaluation information further comprises second evaluation information, the first evaluation information has a hierarchical relationship with the second evaluation information, a level to which the first evaluation information belongs is higher than a level to which the second evaluation information belongs, a plurality of pieces of second evaluation information corresponds to the same first evaluation information, and wherein displaying the virtual widget comprising the first evaluation information and the type information of the resource provided by the virtual room comprises:
displaying a virtual widget comprising the first evaluation information, the second evaluation information and the type information of the resource provided by the virtual room in the live interface.

4. The method of claim 1, wherein before displaying the visual element corresponding to the virtual room in the live interface, the method further comprises:
acquiring a preset resource type configured for the virtual room; and
determining the type of the resource provided by the virtual room according to the preset resource type.

5. The method of claim 4, wherein determining the type of the resource provided by the virtual room according to the preset resource type comprises:
in a case that one preset resource type exists, determining the type of the resource provided by the virtual room according to the one preset resource type; and
in a case that at least two preset resource types exist, determining a target resource type from the at least two preset resource types according to historical resource supply quantity information for each of the at least two preset resource types for the virtual room, and determining the type of the resource provided by the virtual room according to the target resource type:
wherein a historical resource supply quantity corresponding to the target resource type is greater than a historical resource supply quantity corresponding to other preset resource type in the virtual room.

6. The method of claim 1, wherein after displaying the visual element corresponding to the virtual room in the live interface, the method further comprises:
in a case that it is detected that a target user account enters the virtual room, displaying an entry prompt message for the target user account in the live interface:
wherein the target user account has a target user identifier, the target user identifier indicates that an interaction degree of the target user account in a target domain is higher than a set threshold, and the target domain is a domain corresponding to the type of the resource provided by the virtual room.

7. The method of claim 1, wherein after displaying the visual element corresponding to the virtual room in the live interface, the method further comprises:
in a case that target tag information corresponding to the virtual room is acquired, displaying the target tag information at a peripheral position of the visual element:
wherein the target tag information comprises at least one of the historical interaction object feature information, resource interaction activity information, and user evaluation information corresponding to the virtual room.

8. The method of claim 7, wherein displaying the target tag information at the peripheral position of the visual element comprises:
in a case that the target tag information acquired is one type of tag information, periodically displaying the target tag information according to a set time interval; and
in a case that the target tag information acquired is at least two types of tag information, alternately displaying the at least two types of tag information in a set order.

9. An electronic device, comprising:
a processor; and
a memory for storing instructions executable by the processor:
wherein the processor is configured to execute the instructions to implement operations, comprising:
in response to an operation of entering a virtual room, displaying a live interface of the virtual room, and displaying a visual element corresponding to the virtual room in the live interface, wherein the visual element comprises a type of a resource provided by the virtual room, and current evaluation information of the virtual room with the type of the resource; and
in response to a trigger operation on the visual element, displaying an information window corresponding to the virtual room on the live interface, and displaying the visual element and historical interaction object feature information corresponding to the virtual room in the information window.

10. The electronic device of claim 9, wherein the current evaluation information comprises first evaluation information, and the virtual room has different visual element styles corresponding to different first evaluation information, and wherein the processor is configured to:
display a virtual widget comprising the first evaluation information and type information of the resource provided by the virtual room, in the visual element style corresponding to the first evaluation information, in the live interface as the visual element corresponding to the virtual room.

11. The electronic device of claim 10, wherein the current evaluation information further comprises second evaluation information, the first evaluation information has a hierarchical relationship with the second evaluation information, a level to which the first evaluation information belongs is higher than a level to which the second evaluation information belongs, a plurality of pieces of second evaluation information corresponds to the same first evaluation information, and wherein the processor is configured to:
display a virtual widget comprising the first evaluation information, the second evaluation information and the type information of the resource provided by the virtual room in the live interface.

12. The electronic device of claim 9, wherein the processor is configured to:
acquire a preset resource type configured for the virtual room; and
determine the type of the resource provided by the virtual room according to the preset resource type.

13. The electronic device of claim 12, wherein the processor is configured to:
in a case that one preset resource type exists, determine the type of the resource provided by the virtual room according to the one preset resource type; and
in a case that at least two preset resource types exist, determine a target resource type from the at least two preset resource types according to historical resource supply quantity information for each of the at least two preset resource types for the virtual room, and determining the type of the resource provided by the virtual room according to the target resource type:
wherein a historical resource supply quantity corresponding to the target resource type is greater than a historical resource supply quantity corresponding to other preset resource type in the virtual room.

14. The electronic device of claim 9, wherein the processor is configured to:
in a case that it is detected that a target user account enters the virtual room, display an entry prompt message for the target user account in the live interface;
wherein the target user account has a target user identifier, the target user identifier indicates that an interaction degree of the target user account in a target domain is higher than a set threshold, and the target domain is a domain corresponding to the type of the resource provided by the virtual room.

15. The electronic device of claim 9, wherein the processor is configured to:
in a case that target tag information corresponding to the virtual room is acquired, display the target tag information at a peripheral position of the visual element:
wherein the target tag information comprises at least one of the historical interaction object feature information, resource interaction activity information, and user evaluation information corresponding to the virtual room.

16. The electronic device of claim 15, wherein the processor is configured to:
in a case that the target tag information acquired is one type of tag information, periodically display the target tag information according to a set time interval; and
in a case that the target tag information acquired is at least two types of tag information, alternately display the at least two types of tag information in a set order.

17. A non-transitory computer-readable storage medium having stored therein instructions that, in response to the instructions being executed by a processor of an electronic device, cause the electronic device to perform operations, comprising:
in response to an operation of entering a virtual room, displaying a live interface of the virtual room, and displaying a visual element corresponding to the virtual room in the live interface, wherein the visual element comprises a type of a resource provided by the virtual room, and current evaluation information of the virtual room with the type of the resource; and
in response to a trigger operation on the visual element, displaying an information window corresponding to the virtual room on the live interface, and displaying the visual element and historical interaction object feature information corresponding to the virtual room in the information window.

18. The non-transitory computer-readable storage medium of claim 17, wherein the current evaluation information comprises first evaluation information, and the virtual room has different visual element styles corresponding to different first evaluation information, and wherein the electronic device is configured to perform:
displaying a virtual widget comprising the first evaluation information and type information of the resource provided by the virtual room, in the visual element style corresponding to the first evaluation information, in the live interface as the visual element corresponding to the virtual room.

19. The non-transitory computer-readable storage medium of claim 18, wherein the current evaluation information further comprises second evaluation information, the first evaluation information has a hierarchical relationship with the second evaluation information, a level to which the first evaluation information belongs is higher than a level to which the second evaluation information belongs, a plurality of pieces of second evaluation information corresponds to the same first evaluation information, and wherein the electronic device is configured to perform:
displaying a virtual widget comprising the first evaluation information, the second evaluation information and the type information of the resource provided by the virtual room in the live interface.

20. The non-transitory computer-readable storage medium of claim 17, wherein before displaying the visual element corresponding to the virtual room in the live interface, the electronic device is configured to perform:
acquiring a preset resource type configured for the virtual room; and
determining the type of the resource provided by the virtual room according to the preset resource type.
